(19) United States
(12) Patent Application Publication
(10) Pub. No.: US 2013/0179132 A1
(43) Pub. Date: Jul. 11, 2013

(54) Analysis Method, Apparatus and Software for a System With Frequency Dependent Materials

(71) Applicants: Endre Barti, Munchen (DE); Utz Wever, Munchen (DE)

(72) Inventors: Endre Barti, Munchen (DE); Utz Wever, Munchen (DE)

(21) Appl. No.: 13/825,414

(22) PCT Filed: Aug. 31, 2011
(86) PCT No.: PCT/EP2011/065019

§ 371 Date: Mar. 21, 2013

(30) Foreign Application Priority Data
Sep. 22, 2010 (EP) 10178381.9

(51) Int. Cl. G06F 17/50

(52) U.S. Cl. CPC G06F 17/5018
USPC 703/2

(57) ABSTRACT

An analysis method, apparatus and computer software for a system including frequency dependent materials practiced via an analysis apparatus are disclosed. Frequency dependent information regarding a plurality of variables characteristic for the frequency dependant material is imported, a characteristic relationship for the frequency where a system response has a peak value is provided, wherein a value of a frequency provided into the analysis apparatus is equal to a frequency where the system response has a peak, the characteristic relationship is solved by applying an iteration sequence, and a plurality of frequency values are obtained that define the system response peaks for the frequency dependant material, wherein the response is one of an amplitude of the oscillation, and stress.

### CROSS-REFERENCE TO RELATED APPLICATIONS

This application is a U.S. National Stage Application of International Application No. PCT/EP2011/065019 filed Aug. 31, 2011, which designates the United States of America, and claims priority to EP Patent Application No. 10178381.9 filed Sep. 22, 2010. The contents of which are hereby incorporated by reference in their entirety.

### TECHNICAL FIELD

The present disclosure relates generally to the field of materials analysis and more particularly to an analysis method, apparatus and computer software for studying the behavior of systems comprising frequency dependent materials, the method and computer software being practiced via an analysis apparatus.

### BACKGROUND

Today's modern devices, for example in the field of medical devices, make use to a large degree of polymer materials, and sometimes are built in their entirety of polymer materials.

Polymers are used in the manufacture of medical devices, technical devices, and many others. During their development phase, said devices go through multiple testing phases during which, among others, their behavior is reviewed versus the applied frequency.

Traditionally, following the design phase of a technical device, a prototype of the medical device is built, that is tested, and possibly many other prototypes of the device need to be built and tested till the design phase of the technical device is completed. Therefore the testing phase involves use of time and materials, especially if various defects are detected and more new prototypes need to be build for continued testing. Further, should a defect be detected upon testing the ready prototype, the defect is sometimes corrected by changing the materials employed for building the device or by changing the geometry of the parts. This in turn leads to more testing cycles that need to be performed, upon new prototypes that need to be continually manufactured.

Other examples apart from medical devices that comprise elastomers that suffer from the same problems are cooling tubes employed in car engines.

Therefore, a need exists for reducing the amount of time necessary, and resources employed during the testing of devices comprising elastomers and polymers.

Usually the amount of time and resources necessary has been proposed to be reduced by performing exclusively computer simulation of the devices to be built and attempting to develop and test all the constructional details of the device intended to be realized via computer simulation. As such the need for building and testing actual prototypes is eliminated.

The virtual testing of the devices posses a plurality of other problems such as is very difficult to accurately reproduce the behavior of materials that are frequency dependent, such as polymers and rubbers, to reproduce the behavior of technical assemblies, to reproduce the behavior of contact regions between components, especially if the device is intended to be realized via a material that has a non linear behavior, such as rubber and polymers.

Regarding these contact regions and materials a modal, or a harmonic analysis is not applicable. Currently is only possible to make, via commercial simulation tools, a linear analysis of the structural mechanics for materials. Said simulation tools do not work for materials that are frequency dependant. Further, the simulation tools currently available do not allow simulating the dynamical behavior of materials that are frequency dependant or the dynamical behavior of assemblies comprising frequency dependant materials, especially in a frequency range from 1 to 30,000 Hz.

Therefore, a need still exists for a simulation tool capable of performing accurate simulation in the frequency domain of the behavior of materials that are frequency dependant. Further, a need still exists for an apparatus that permits the dynamical simulation of the behavior of materials that are frequency dependant.

### SUMMARY

One embodiment provides an analysis method for simulating the dynamical behavior of parts and assemblies containing frequency dependent materials in a system, comprising: importing frequency dependent information regarding a plurality of variables characteristic for the parts and assemblies containing frequency dependant materials; stating a characteristic relationship for an eigenvalue of a frequency of said parts and assemblies containing frequency dependant materials, wherein the characteristic relationship takes into account at least one of the plurality of variables characteristic for the frequency dependant material; and wherein a value of an imported frequency employed for the computation of the at least one of the plurality of variable characteristics for the frequency dependant materials is equal to a peak frequency of the system; solving the characteristic relationship by applying an iteration sequence to obtain a plurality of frequency values that define said response peaks for the frequency dependant material, wherein said at least one of the plurality of variable characteristics for the frequency dependant material is one of an amplitude of the oscillation, and stress, and wherein said characteristic relationship is

f_{(ω)}=Iₘ(λ(ω))−½πω=0

where Iₘ(λ(ω)) is the imaginary part function of the eigenvalue of a frequency of said assembly, and ½πω is the input frequency for the frequency dependent material properties.

In a further embodiment, a frequency dependant material is one of a polymer and a rubber.

In a further embodiment, said plurality of variables characteristic for the frequency dependent materials comprises at least one of Young's modulus, Poisson's ratio, and loss factor or damping coefficient.

In a further embodiment, damping and stiffness have a matrix representation.

In a further embodiment, said plurality of variables characteristic for the frequency dependant material are imported from commercially available tables, and databases listing materials properties.

In a further embodiment, said peak value of the system response is defined by an eigenvalue with a real and an imaginary part, and wherein the eigenvalue is frequency dependent.

In a further embodiment, said damping matrix and said stiffness matrix are frequency dependent.

In a further embodiment, said iteration is one of a Gauss-Seidel iteration and a Newton's method.

Another embodiment provides an analysis apparatus for simulating the dynamical behavior of parts and assemblies containing frequency dependent materials in a system, comprising: means for importing frequency dependent information regarding a plurality of variables characteristic for the parts and assemblies containing frequency dependent materials; means for stating a characteristic relationship for an eigenvalue of a frequency of said parts and assemblies containing frequency dependant materials, wherein the characteristic relationship takes into account at least one of the plurality of variables characteristic for the frequency dependant material, and wherein a value of an imported frequency employed for the computation of the at least one of the plurality of variable characteristics for the frequency dependant materials is equal to a peak frequency of the system; means for solving the characteristic relationship by applying an iteration sequence to obtain a plurality of frequency values that define said response peak for the frequency dependant material, wherein said at least one of the plurality of variable characteristics for the frequency dependant material is one of an amplitude of the oscillation, and stress, and wherein said characteristic relationship is

f _{(ω)}=Iₘ(λ(ω))−½πω=0

where Iₘ(λ(ω)) is the imaginary part function of the eigenvalue of a frequency of said assembly, and ½πω is the input frequency for the frequency dependent material properties.

In a further embodiment, said means for storing said information are a memory, and wherein said memory stores an iteration sequence.

In a further embodiment, said means for stating a characteristic relationship for a peak value of a frequency are software storing and running means.

In a further embodiment, said means for solving the characteristic relationship by applying an iteration sequence are a processor.

In a further embodiment, said means for obtaining a plurality of frequency values comprise display means, and wherein said display means display said data as one of a graph and a collection of values.

Another embodiment provides an analysis software means for simulating the dynamical behavior of parts and assemblies containing frequency dependent materials in a system, the software enabling: importing frequency dependent information regarding a plurality of variables characteristic for the parts and assemblies containing frequency dependant materials; stating a characteristic relationship for an eigenvalue of a frequency of said parts and assemblies containing frequency dependant materials, wherein the characteristic relationship takes into account at least one of the plurality of variables characteristic for the frequency dependant material; and wherein a value of an imported frequency employed for the computation of the at least one of the plurality of variable characteristics for the frequency dependant materials is equal to a peak frequency of the system; solving the characteristic relationship by applying an iteration sequence to obtain a plurality of frequency values that define said response peaks for the frequency dependant material, wherein said at least one of the plurality of variable characteristics for the frequency dependant material is one of an amplitude of the oscillation, and stress, and wherein said characteristic relationship is

f_{(ω)}=Iₘ(λ(ω))−½πω=0

where Iₘ(λ(ω)) is the imaginary part function of the eigenvalue of a frequency of said assembly, and ½πω is the input frequency for the frequency dependent material properties.

### BRIEF DESCRIPTION OF THE DRAWINGS

Exemplary embodiments will be explained in more detail below on the basis of the schematic drawings, wherein:

FIG. 1 illustrates the dependency of the Young's module with the frequency in the case of polymers;

FIG. 2 is a representation of how the material oscillates with the frequency obtained applying the finite method of analysis, and

FIG. 3 is a representation of a flow chart of a method according to an example embodiment.

### DETAILED DESCRIPTION

An analysis method for a system comprising frequency dependent materials, practiced by an analysis apparatus is proposed herein. The method may comprise at least importing a frequency dependent information regarding a plurality of variables characteristic for the frequency dependant material, providing a characteristic relationship for the frequency where a system response has a peak value, wherein a value of a frequency provided into the analysis apparatus is equal to a frequency where the system response has a peak, solving the characteristic relationship by applying an iteration sequence, and obtaining a plurality of frequency values that define the system response peaks for the frequency dependant material, wherein response is one of an amplitude of the oscillation, stress or other response.

According to another embodiment an analysis apparatus for studying the behavior of a system comprising frequency dependant materials is proposed. The apparatus comprises means for importing a frequency dependent information regarding a plurality of variables characteristic for the frequency dependant material, means for providing a characteristic relationship for the frequency where the system response has a peak value, wherein a value of a frequency provided into the analysis apparatus is equal to a frequency where the system response has a peak, means for solving the characteristic relationship by applying an iteration sequence, and means for obtaining a plurality of frequency values that define the system response peaks for the frequency dependant material, wherein the response is one of amplitude of the oscillation, stress or other response.

According to yet another embodiment an analysis software means for a system comprising frequency dependent materials residing into an analysis apparatus are proposed. The proposed software enables importing a frequency dependent information regarding a plurality of variables characteristic for the frequency dependant material, providing a characteristic relationship for the frequency where a system response has a peak value, wherein a value of a frequency provided into said analysis apparatus is equal to a frequency where the system response has a peak, solving the characteristic relationship by applying an iteration sequence, and obtaining a plurality of frequency values that define said system response peaks for the frequency dependant material, wherein the response is one of an amplitude of the oscillation, stress or other response.

The analysis method for a system comprising frequency dependent materials as disclosed herein is applied for frequency dependant materials such as elastomeric compounds, polymers and rubbers.

For the analysis method for a system comprising frequency dependent materials as disclosed herein the plurality of variables characteristic for the frequency dependent materials comprises at least one of Young's modulus (E), Poisson's ratio, and loss factor or damping coefficient.

For the analysis method for a system comprising frequency dependent materials as disclosed herein the plurality of variables characteristic for the frequency dependent materials damping (C) and stiffness (K) have a matrix representation.

In the method proposed herein the plurality of variables characteristic for the frequency dependant material are imported from commercially available tables, and databases listing materials properties. For the analysis method for a system comprising frequency dependent materials of the present the peak value of the system response is defined by an eigenvalue with a real and an imaginary part, and the eigenvalue is frequency dependent.

For the analysis method for a system comprising frequency dependent materials as disclosed herein the matrices C, and K are frequency dependent. For the analysis method for a system comprising frequency dependent materials as disclosed herein said characteristic relationship for a system response peak value is f_{(ω)=I}ₘ(λ(ω))−½πω=0, where λ(ω) is the eigenvalue of the linear frequency analysis.

For the analysis method for a system comprising frequency dependent materials as disclosed herein the iteration is one of a Gauss-Seidel iteration and a Newton's method. For the analysis method for a system comprising frequency dependent materials as disclosed herein the method is employed for simulating the dynamical behavior of parts and assemblies containing frequency dependent materials.

The disclosed method permits determining the desired frequency eigenvalues via a mathematical equation which is solved efficiently, in contrast with the method know from the art that assume that accurate scanning of the frequency range was necessary in order to obtain desired frequency eigenvalues and the corresponding mode shapes. This approach used in the art is extremely expensive in terms of computation time. As mentioned above the disclosed method determines the desired eigenfrequency by a mathematical equation that may be solved efficiently. Besides the enormous computational time and capacity savings the new method delivers accurate results, because the desired value is determined as a solution to an equation.

Regarding the disclosed apparatus, the means for storing the information are a memory, and the memory stores an iteration sequence. The means for stating a characteristic relationship for a peak value of a frequency are software storing and running means.

Regarding the disclosed apparatus the means for solving the characteristic relationship by applying an iteration sequence are a processor, the means for obtaining a plurality of frequency values comprise among others display means, and the display means display the data as one of a graph and a collection of values.

The materials such as polymers and rubbers are special materials since their characteristics are not constant but are frequency dependent. Examples of such variables are the Young's modulus (E), the Poisson's ratio and the loss factor.

While studying the behaviors of devices constructed from polymers and rubbers the oscillation, movement, vibration of the materials is studied. In the art are known attempts to study said behaviors via an equation such as:

Mü(t)+C(f)\dot{u}(t)+K(f)u(t)=0 (1)

### Where:

M is the mass matrix;
ü(t) is the second derivative, acceleration, indicative of the displacement of the material or indicated how the material oscillates/moves;
C(f) is the damping matrix;
\dot{u}(t) is the first derivative, velocity;
K(f) is the stiffness matrix;
u(t) is the function describing the displacement,
t is time, and f is frequency.

In the art the above equation is attempted to be solved in the time domain. Obtaining a solution to the above equation in the time domain is a lengthy and a time consuming process. Further, the solution process consumes a large computing power.

In the art the equation is also attempted to be solved in the frequency domain, such as for application where the equation is intended to be used to simulate the frequency dependent behavior of devices made of polymers. In the art the above equation is attempted to be solved by considering that the non-linear dependency of Young's module and the damping with respect to frequency are given by discrete points.

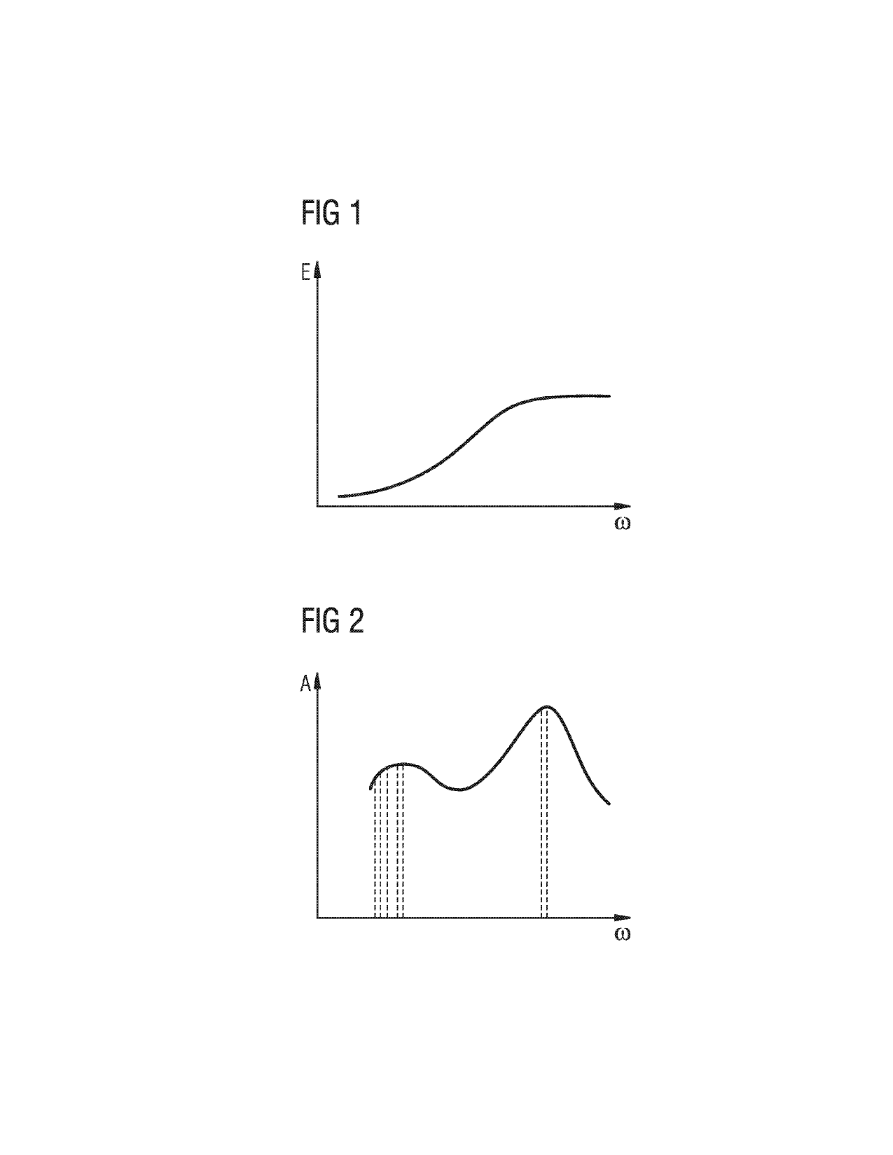

While referring to the illustration of FIG. 1, FIG. 1 represents the dependency of the Young's modulus with the frequency in the case of polymers.

Referring now to the illustration of FIG. 2, FIG. 2 is a representation of the amplitude versus frequency for a material whose behavior is frequency dependent. In order to simulate the behavior of the frequency dependent material the curve has been obtained by choosing a plurality of many values in the frequency domain and the corresponding amplitude is computed on the curve. Some of the obtained points on the curve correspond to frequency peaks that are attempted to be calculated to fully characterize the behavior of the frequency dependent material. Such a process of identification of the frequency peaks is time and resources intensive, and does not lead to sufficiently accurate results.

Referring back to the attempt to solve the above equation in the frequency domain, similarly as above, a plurality of discrete values are given at least for the Young's modulus and the damping coefficient, (fᵢ, E(fᵢ), C(fᵢ)), i=1, . . . , n.

Following the choice of the plurality of discrete values the equation is attempted to be solved in the frequency domain

Mü(t)+C(f)\dot{u}(t)+K(f)u(t)=cos(2πfᵢt), i=1, . . . n. (2)

When solved in the frequency domain, for applications where it is intended to simulate the frequency dependent behavior of devices made of polymers and rubbers the right side of the equation is artificially excited to cos(2πfᵢt). The solution to the equation is expected to indicate a curve behavior.

Similarly to how it is represented in FIG. 2, the solutions to with the highest amplitude denote the peak values. But in order to obtain a good approximation for the peak values of the frequencies, the equation must be solved several hundred of times. Such solution algorithms are usually automated, and are exemplarily implemented in finite element methods ANSYS or FemLab, which are the most frequently used software for structural mechanics simulation. Further, in order to provide accurate results a long time and large computing power is needed.

Therefore, a need still exists for a simulation tool capable of performing accurate simulation of the behavior of materials that are frequency dependant. Further, a need still exists for a tool that permits the dynamical simulation of the behavior of materials that are frequency dependant.

The present disclosure proposes a solution to the above referenced problem for example by proposing a simulation tool that employs an analysis method for systems comprising frequency dependent materials comprising importing a frequency dependence information regarding a plurality of variables characteristic for the frequency dependant material, stating a characteristic relationship for a peak value of a frequency, the characteristic relationship taking into account at least one of the plurality of variables characteristic for the frequency dependant material, assuming that a value of a frequency provided to the analysis apparatus is equal with one of a plurality of peak frequency values, solving the characteristic relationship by applying an iteration sequence, and obtaining a plurality of frequency values that define the plurality of frequency peaks for the frequency dependant material studied.

Specifically, the present disclosure considers solving the specified equation via an iteration method directly for the autonomous case. The key observation is that the input frequency for the computation of the Young's modulus and the damping matrix must be equal with the peak frequency of the system.

Therefore it is stated a characteristic relationship for an eigenvalue of a frequency, the characteristic relationship taking into account at least one of the plurality of variables characteristic for the frequency dependant material:

f_{(ω)}=Iₘ(λ(ω))−½πω=0 (3)

where Iₘ(λ(ω)) stands for the imaginary part function of the eigenvalue for the autonomous system of the equation 1, which defines the frequency, and ½πω stands for the input frequency for the frequency dependent material properties, wherein the eigenvalue defined the frequency of the system.

In order to solve equation 3, solving the characteristic relationship at least two iteration methods may be applied: the Gauss-Seidel type iteration and the Newton method.

Referring back to equation 1, that is employed to be solve in frequency values, the frequency dependence information regarding a plurality of variables characteristic for the frequency dependant material comprised in equation 1 are imported from available sources. Said sources may be commercially available tables and databases.

It is assumed that a value of a frequency provided to the analysis apparatus is equal with one of a plurality of peak frequency values.

The Gauss-Seidel type iteration starts with an initial value and evaluates the system. The solution is taken as the next value and the system is evaluated again. This process is repeated and continued to be performed till convergence.

The Gauss-Seidel type iteration has the advantage that a FEM-software can be used as a black box.

The Newton method is an iteration that starts with an initial value. Because the Newton iteration is an iteration that also uses gradient information, the convergence rate is larger, when compared to the Gauss-Seidel type iteration, and as such requires less system evaluations.

With the perturbation theory for eigenvalues, the derivatives of the eigenvalues with respect to the frequency may be computed. The advantage of Newton's method is the fast quadratic convergence. However the computation of the derivative requires the matrices M, C, K from the FEM model, which leads to more complex program structure.

The analysis described above is employed for simulating the dynamical behavior of assemblies comprising frequency dependent materials. Both methods work very efficiently and save hundred of FEM-computation in comparison with the state of the art methods.

In all of the above it is assumed that a frequency dependant material is a polymer and a rubber. The plurality of variables characteristic for the frequency dependent materials comprises at least one of Young's modulus (E), Poisson's ratio and loss factor, where the plurality of variables for the frequency dependent materials have a matrix representation.

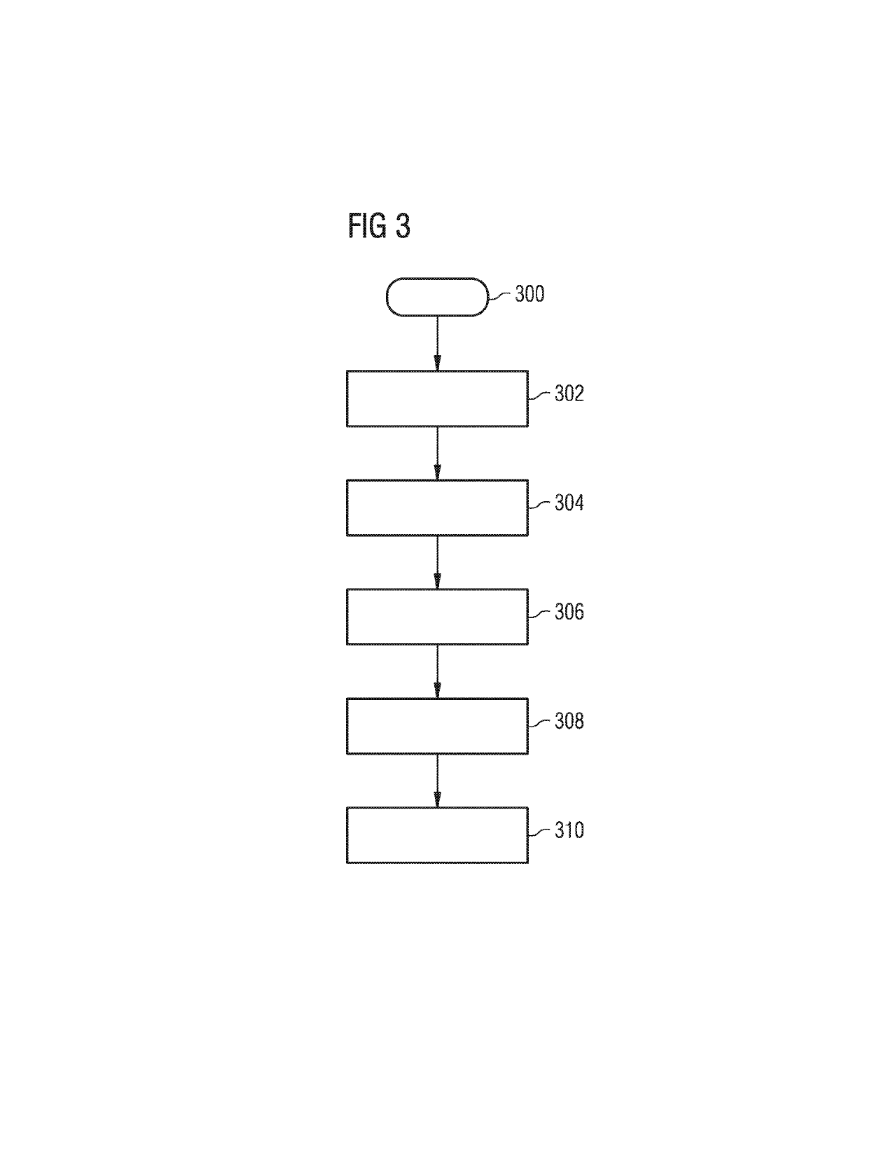

Referring now to FIG. 3, FIG. 3 is a representation of a flow chart of a method according to the present disclosure.

The method of FIG. 3 comprises at least the step of importing a frequency dependence information, 302, regarding a plurality of variables characteristic for the frequency dependant material, the step of stating a characteristic relationship, 304, for the frequency where a system response has a peak value, a value of a frequency provided into the analysis apparatus being equal to a frequency where the system response has a peak, the step of solving 306, the characteristic relationship by applying an iteration sequence, and the step of obtaining 308 a plurality of frequency values that define the system response peaks for the frequency dependant material, while the response is 310 one of an amplitude of the oscillation, and stress.

The analysis method described in detail above in connection with FIG. 3 is used for and in the simulating the dynamical behavior of assemblies comprising frequency dependent materials.

The present disclosure is also directed to an analysis apparatus for studying the behavior of a system comprising frequency dependant materials. The analysis apparatus, appropriate to be employed for performing simulation of the frequency dependant materials, comprises at least means for importing a frequency dependent information regarding a plurality of variables characteristic for the frequency dependant material, means for providing a characteristic relationship for the frequency where the system response has a peak value, wherein a value of a frequency provided into the analysis apparatus is equal to a frequency where the system response has a peak, means for solving the characteristic relationship by applying an iteration sequence, and means for obtaining a plurality of frequency values that define the system response peaks for the frequency dependant material, wherein the response is one of amplitude of the oscillation, stress or other response.

In the analysis apparatus the means for storing the information are a memory, the means for stating a characteristic relationship for a peak value of a frequency are software storing and running means, and the means for solving the characteristic relationship by applying an iteration sequence are a processor. The means for obtaining a plurality of frequency values are envisioned to comprise among others display means. The above enumeration of means is exemplary and for the specific implementation of said means the person skilled in the art may envision alternative implementations.

The present disclosure is also directed to an analysis software means for a system comprising frequency dependent materials, software residing into the analysis apparatus. The software enables the disclosed method to import a frequency dependent information regarding a plurality of variables characteristic for the frequency dependant material, to provide a characteristic relationship for the frequency where a system response has a peak value, wherein the value of a frequency provided into the analysis apparatus is equal to a frequency where the system response has a peak, to solve the characteristic relationship by applying an iteration sequence, and to obtain a plurality of frequency values that define the system response peaks for the frequency dependant material, wherein the response is one of an amplitude of the oscillation, and stress.

The analysis method described in detail above in connection with FIG. 3 is used for and in the simulating the dynamical behavior of systems and assemblies comprising frequency dependent materials.

Although the present disclosure has been disclosed in the form of preferred embodiments and variations thereon, it will be understood that numerous additional modifications and variations could be made thereto without departing from the scope of the invention. For the sake of clarity, it is to be understood that the use of “a” or “an” through this application does not exclude a plurality, and “comprising: does not exclude other steps or elements. A “unit”, or “module” can comprise a number of units or modules, unless otherwise stated.

What is claimed is:

1. An analysis method for simulating the dynamical behavior of parts and assemblies containing frequency dependent materials in a system, comprising:
importing frequency dependent information regarding a plurality of variables characteristic for the parts and assemblies containing frequency dependant materials;
stating a characteristic relationship for an eigenvalue of a frequency of said parts and assemblies containing frequency dependant materials,
wherein the characteristic relationship takes into account at least one of the plurality of variables characteristic for the frequency dependant material; and
wherein a value of an imported frequency employed for the computation of the at least one of the plurality of variable characteristics for the frequency dependant materials is equal to a peak frequency of the system;
solving the characteristic relationship by applying an iteration sequence to obtain a plurality of frequency values that define said response peaks for the frequency dependant material,
wherein said at least one of the plurality of variable characteristics for the frequency dependant material is one of an amplitude of the oscillation, and stress, and wherein said characteristic relationship is
f_{(ω)}=Iₘ(λ(ω))−½πω=0
where Iₘ(λ(ω)) is the imaginary part function of the eigenvalue of a frequency of said assembly, and ½πω is the input frequency for the frequency dependent material properties.

2. The method of claim 1, wherein a frequency dependant material is one of a polymer and a rubber.

3. The method of claim 1, wherein said plurality of variables characteristic for the frequency dependent materials comprises at least one of Young's modulus (E), Poisson's ratio, and loss factor or damping coefficient.

4. The method of claim 3, wherein damping (C) and stiffness (K) have a matrix representation.

5. The method of claim 1, wherein said plurality of variables characteristic for the frequency dependant material are imported from commercially available tables, and databases listing materials properties.

6. The method of claim 1, wherein said peak value of the system response is defined by an eigenvalue with a real and an imaginary part, and wherein the eigenvalue is frequency dependent.

7. The method of claim 4, wherein said damping matrix (C) and said stiffness matrix (K) are frequency dependent.

8. The method of claim 1, wherein said iteration is one of a Gauss-Seidel iteration and a Newton's method.

9. An analysis apparatus for simulating the dynamical behavior of parts and assemblies containing frequency dependent materials in a system, comprising:
means for importing frequency dependent information regarding a plurality of variables characteristic for the parts and assemblies containing frequency dependent materials ;
means for stating a characteristic relationship for an eigenvalue of a frequency of said parts and assemblies containing frequency dependant materials,
wherein the characteristic relationship takes into account at least one of the plurality of variables characteristic for the frequency dependant material, and
wherein a value of an imported frequency employed for the computation of the at least one of the plurality of variable characteristics for the frequency dependant materials is equal to a peak frequency of the system;
means for solving the characteristic relationship by applying an iteration sequence to obtain a plurality of frequency values that define said response peak for the frequency dependant material,
wherein said at least one of the plurality of variable characteristics for the frequency dependant material is one of an amplitude of the oscillation, and stress, and wherein said characteristic relationship is
f_{(ω)}=Iₘ(λ(ω))−½πω=0
where Iₘ(λ(ω)) is the imaginary part function of the eigenvalue of a frequency of said assembly, and ½πω is the input frequency for the frequency dependent material properties.

10. The apparatus of claim 9, wherein said means for storing said information are a memory, and wherein said memory stores an iteration sequence.

11. The apparatus of claim 9, wherein said means for stating a characteristic relationship for a peak value of a frequency are software storing and running means.

12. The apparatus of claim 9, wherein said means for solving the characteristic relationship by applying an iteration sequence are a processor.

13. The apparatus of claim 9, wherein said means for obtaining a plurality of frequency values comprise display means, and wherein said display means display said data as one of a graph and a collection of values.

14. An analysis software means for simulating the dynamical behavior of parts and assemblies containing frequency dependent materials in a system, the software enabling:
importing frequency dependent information regarding a plurality of variables characteristic for the parts and assemblies containing frequency dependant materials;
stating a characteristic relationship for an eigenvalue of a frequency of said parts and assemblies containing frequency dependant materials,
wherein the characteristic relationship takes into account at least one of the plurality of variables characteristic for the frequency dependant material; and
wherein a value of an imported frequency employed for the computation of the at least one of the plurality of variable characteristics for the frequency dependant materials is equal to a peak frequency of the system;
solving the characteristic relationship by applying an iteration sequence to obtain a plurality of frequency values that define said response peaks for the frequency dependant material,
wherein said at least one of the plurality of variable characteristics for the frequency dependant material is one of an amplitude of the oscillation, and stress, and wherein said characteristic relationship is
f_{(ω)}=Iₘ(λ(ω))−½πω=0
where Iₘ(λ(ω)) is the imaginary part function of the eigenvalue of a frequency of said assembly, and ½πω is the input frequency for the frequency dependent material properties.
